(19) United States
(12) Patent Application Publication
(10) Pub. No.: US 2008/0056875 A1
(43) Pub. Date: Mar. 6, 2008

(54) Extendible truss boom

(75) Inventors: Darian Ray Romigh, Massillon, OH (US); John D. Boylan, Strasburg, OH (US)

Correspondence Address: NIXON & VANDERHYE, PC, 901 NORTH GLEBE ROAD, 11TH FLOOR, ARLINGTON, VA, 22203, US

(73) Assignee: JLG Industries, Inc., McConnellsburg, PA (US)

(21) Appl. No.: 11/515,774

(22) Filed: Sep. 6, 2006

(51) Int. Cl. B66C 23/00

(52) U.S. Cl. 414/685

(57) ABSTRACT

An extendible truss boom is attachable to a materials handling vehicle. The truss boom includes a connector frame coupleable with the materials handling vehicle. A plurality of truss frame members are affixed at one end to the connector frame and at an opposite end to an end bracket, which defines an extension opening. An extension member is movably supported by the end bracket in the extension opening. The extension member is selectively lockable in the extension opening in a plurality of positions between a fully retracted position and a fully extended position. The extendible truss boom eliminates the need to have multiple booms of different lengths.

### CROSS-REFERENCES TO RELATED APPLICATIONS

(NOT APPLICABLE)

### STATEMENT REGARDING FEDERALLY SPONSORED RESEARCH OR DEVELOPMENT

(NOT APPLICABLE)

### BACKGROUND OF THE INVENTION

The present invention relates to an attachment to a materials handling vehicle and, more particularly, to an extendible truss boom that extends the horizontal reach of the materials handler.

In the design and construction of any material handling equipment, it is generally considered to be particularly advantageous to provide equipment that is versatile in its basic design and that is capable of having various types of attachments mounted thereon to add to the versatility of the equipment. In U.S. Pat. No. 3,836,025 to Olson et al., material handling equipment is disclosed that is versatile in its basic design. The fork lift assembly, which is operatively mounted at the end of a telescoping boom, is pivotal through an upright plane on the material handling truck. Because of the mobility of the truck, the extendibility of the boom, the upright pivoting movement of the boom, and the pivoting of the fork assembly about an upright axis, the equipment is particularly versatile in use and operation. The disclosed equipment also includes a cable attachment, which includes a drop block arrangement. Particularly when using the drop block arrangement of Olson et al., the horizontal reach of the equipment is relatively limited. Although the fork assembly could be permanently elongated in a longitudinal direction, it is not considered practical to have such a permanent attachment that extends significantly beyond the outer end of the boom in a horizontal direction as such an arrangement would undoubtedly ultimately reduce the versatility and possibly even reduce the load carrying capacity of the fork assembly.

U.S. Pat. No. 4,159,059 to Christenson et al. describes a horizontally elongated truss boom that may be detachably interconnected to a forklift section of a material handling truck. Additionally, U.S. Pat. No. 4,540,096 to Orvis describes a truss boom including an extension member in an effort to further extend the horizontal reach of the materials handler.

In the construction trades, framers have used truss boom attachments with telescopic handlers to move and place roof trusses and the like. The required length of the truss boom is a function of the host telescopic handler's rated capacity, length of the truss and other factors. Traditionally, equipment renters and owners have been required to utilize both 12 foot and 15 foot long truss booms to accommodate differing requirements. It would be desirable to provide an extendible truss boom that eliminates the need to have truss booms of different lengths while satisfying capacity requirements.

### BRIEF SUMMARY OF THE INVENTION

The extendible truss boom of the invention provides a truss boom extension that can be extended or retracted by pulling or pushing an extension member in or out. Preferably, the extendible truss boom is manually operated and secured in position via a quick release pin or the like. The truss boom base is provided with a tube or opening at the front that allows the extension to traverse inside it. The extension preferably rides on plastic slider pads to reduce the force necessary to pull it out or push it in and to transmit the loads from the extension to the truss boom base.

In an exemplary embodiment of the invention, a truss boom is attachable to a materials handling vehicle. The truss boom includes a connector frame coupleable with the materials handling vehicle, and a plurality of truss frame members affixed at one end to the connector frame and at an opposite end to an end bracket. The end bracket defines an extension opening. An extension member is movably supported by the end bracket in the extension opening. The extension member is selectively lockable in the extension opening in a plurality of positions between a fully retracted position and a fully extended position. In one arrangement, the truss frame members are affixed to exterior surfaces of the end bracket, and interior surfaces of the end bracket define the extension opening.

Preferably, the truss boom includes three truss frame members. In this context, the three truss frame members may be configured with a first truss member and a second truss member in a bottom position and a third truss member in a top position. The truss frame members may be oriented in a triangular configuration with the first and second truss members defining a triangle base and the third truss member defining a triangle apex. Additionally, the truss frame members may be further oriented in a pyramidal configuration with the one end of the truss members affixed to the connector frame defining a pyramid base and the opposite end of the truss members affixed to the end bracket defining a pyramid apex.

Slider pads may be mounted in the extension opening such that the extension member is displaceable in the extension opening on the slider pads.

In one arrangement, the extension member is lockable in a selected position by a removable pin.

In another exemplary embodiment of the invention, a materials handling vehicle includes a vehicle chassis, a telescoping boom pivotably supported at one end on the vehicle chassis, a load support mechanism pivotably supported on an opposite end of the telescoping boom, and the truss boom of the invention.

### BRIEF DESCRIPTION OF THE DRAWINGS

These and other aspects and advantages of the present invention will be described in detail with reference to the accompanying drawings, in which:

FIG. 1 shows the extendible truss boom of the invention coupled with a materials handling vehicle;

FIG. 2 is a perspective view of the extendible truss boom with the extension member in a retracted position;

FIG. 3 is a perspective view with the extension member in an extended position; and

FIG. 4 is a detailed view of the connection between the connector frame of the truss boom and the materials handling vehicle.

### DETAILED DESCRIPTION OF THE INVENTION

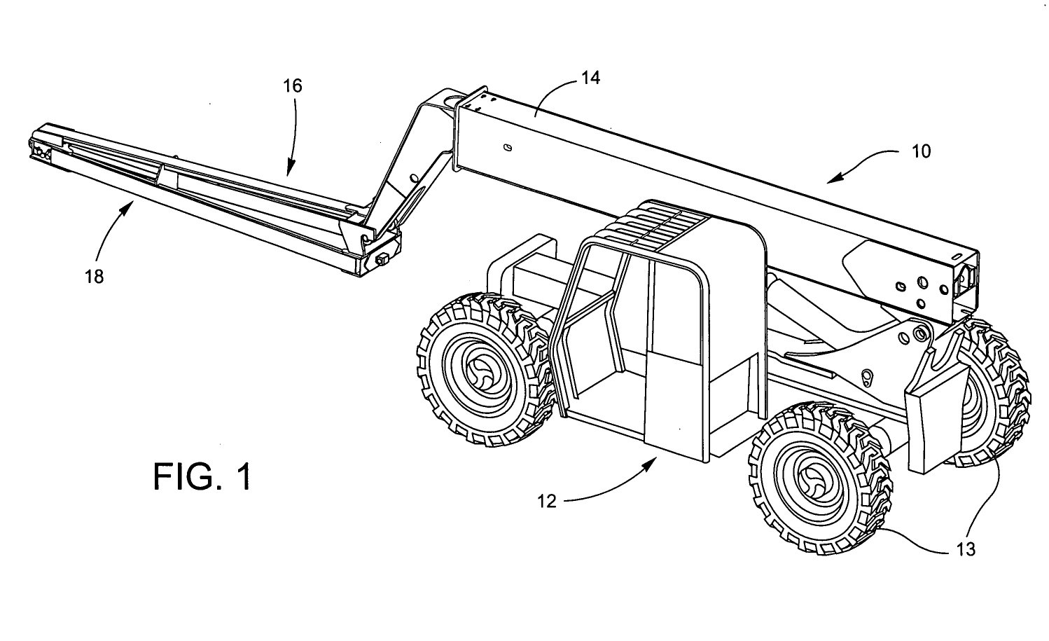

FIG. 1 shows the extendible truss boom of the invention secured to an exemplary materials handling vehicle 10. The vehicle itself does not necessarily form part of the present invention and details of its use and operation will not be described. Generally, the vehicle 10 includes a vehicle chassis 12 supported on wheels 13 driven by a suitable drive system. A telescopic boom 14 is pivotally supported at one end on the vehicle chassis 12. A load support mechanism 16 such as a fork lift or the like is pivotably supported on an opposite end of the telescoping boom 14. The truss boom 18 of the invention is attachable to the materials handling vehicle 10 via the load support mechanism 16.

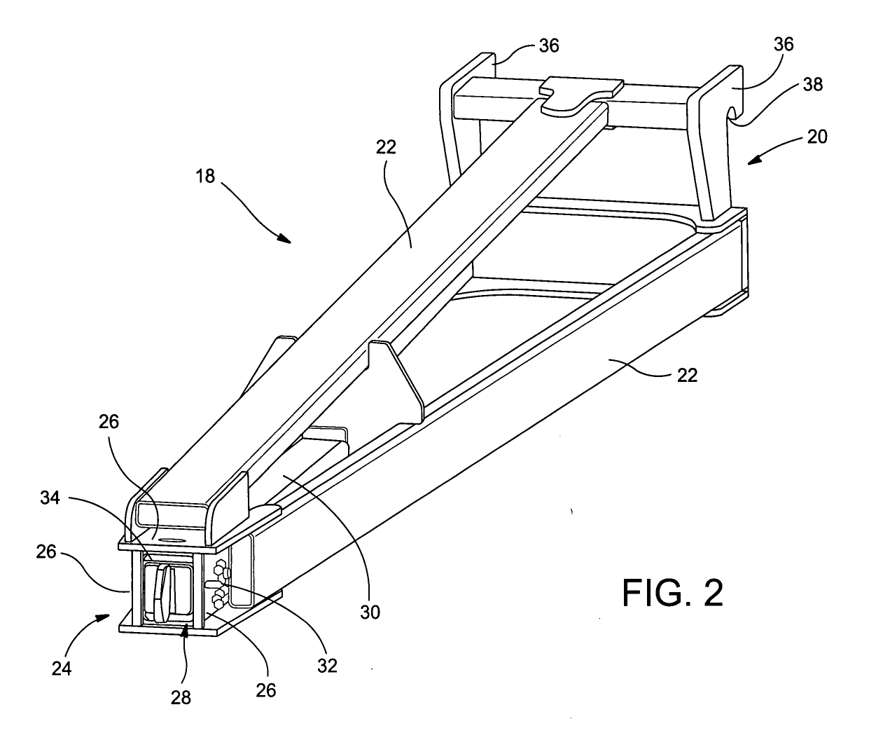

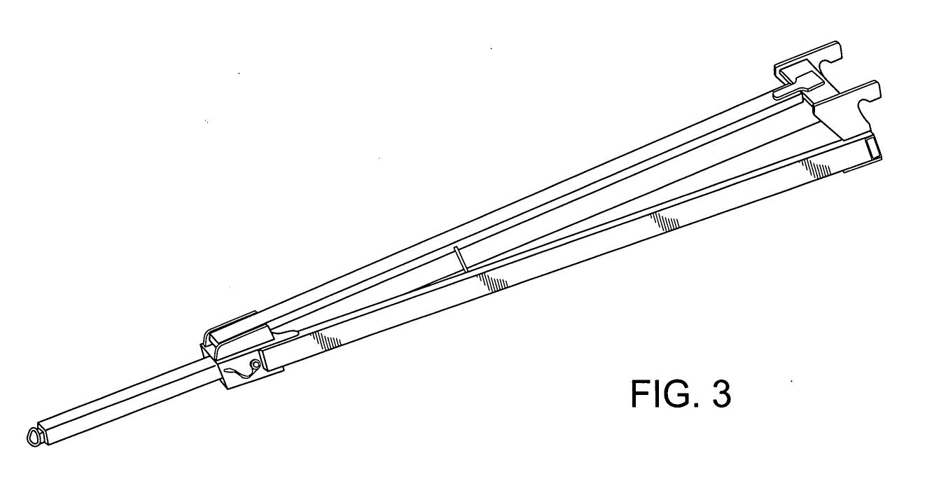

With reference to FIGS. 2 and 3, the truss boom 18 includes a connector frame 20 that is coupleable with the load support mechanism 16 of the materials handling vehicle 10. A plurality of truss frame members 22 are affixed by suitable means at one end to the connector frame 20. An end bracket 24 defines a front end of the truss boom 18. The end bracket 24 includes exterior surfaces 26 to which the truss frame members 22 are suitably connected at an end opposite the connector frame 20.

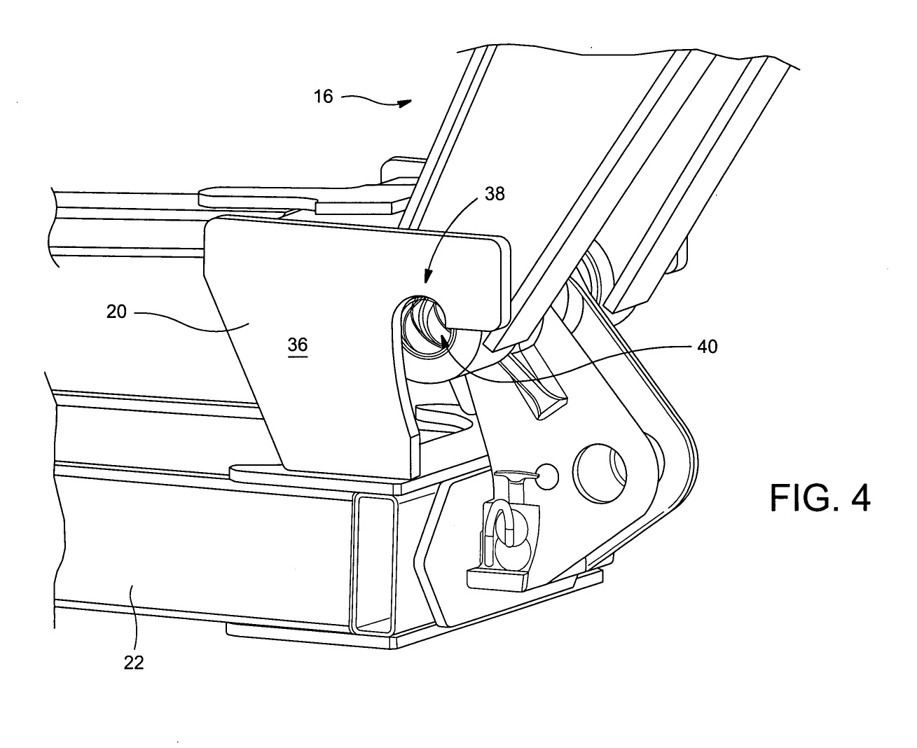

FIG. 4 is a detailed view of an exemplary coupling between the connector frame 20 and the load support mechanism 16. The connector frame 20 includes brackets 36 (see also, FIG. 2) adjacent ends of the truss frame members 22. The brackets 36 are provided with a hook portion 38 that is sized to fit over a coupling pin secured in an aperture 40 through the load support mechanism 16. Those of ordinary skill in the art will appreciate that any suitable coupling structure could be used, and the invention is not necessarily meant to be limited to the described and illustrated structure.

As shown, the truss boom 18 is provided with three truss frame members 22 although more or fewer truss members may be used. In a preferred embodiment, however, the three truss frame members 22 are configured with a first truss member and a second truss member in the bottom position and a third truss member in a top position. That is, the truss frame members 22 are oriented in a triangular configuration with the first and second truss members defining a triangle base and the third truss member defining a triangle apex. In this manner, when the truss boom is loaded with material or the like, the bottom truss members support the load in a state of compression and are thus subject to buckling loads. It is preferable to utilize two truss frame members 22 to resist the buckling loads. The top truss member, however, supports the load in tension, and a single truss frame member 22 is typically suitable for the materials load. Additionally, the truss frame members 22 are preferably further oriented in a pyramidal configuration with the one end of the truss members 22 affixed to the connector frame 20 defining a pyramid base and the opposite end of the truss members 22 affixed to the end bracket 24 defining a pyramid apex.

The end bracket 24 defines an extension opening 28 therein via its internal surfaces as shown. The extension opening 28 is sized to receive an extension member 30. Preferably, the extension member 30 is manually movable in the extension opening in a plurality of positions between a fully retracted position (shown in FIG. 2) and a fully extended position (shown in FIG. 3). A locking mechanism 32 such as a quick release pin or the like can be inserted through the extension member 24 into a corresponding opening in the extension member 30 to lock the extension member in a desired position.

Slider pads 34 may be mounted in the extension opening 28 to facilitate extension and retraction of the extension member 30.

With the extendible truss boom of the invention, it is not necessary to acquire multiple varying length truss booms to accommodate differing requirements. Moreover, the truss boom of the invention can be easily adjusted. Additionally, the design is low profile so that it can be placed underneath the materials handling vehicle during shipping and transport to the job site. In this manner, the customer can deliver the truss boom, machine and carriage on a single truck.

While the invention has been described in connection with what is presently considered to be the most practical and preferred embodiments, it is to be understood that the invention is not to be limited to the disclosed embodiments, but on the contrary, is intended to cover various modifications and equivalent arrangements included within the spirit and scope of the appended claims.

1. A truss boom attachable to a materials handling vehicle, the truss boom comprising:
a connector frame coupleable with the materials handling vehicle;
a plurality of truss frame members affixed at one end to the connector frame and at an opposite end to an end bracket, the end bracket defining an extension opening; and
an extension member movably supported by the end bracket in the extension opening, the extension member being selectively lockable in the extension opening in a plurality of positions between a fully retracted position and a fully extended position.

2. A truss boom according to claim 1, wherein the truss frame members are affixed to exterior surfaces of the end bracket, and wherein interior surfaces of the end bracket define the extension opening.

3. A truss boom according to claim 1, comprising three truss frame members.

4. A truss boom according to claim 3, wherein the three truss frame members are configured with a first truss member and a second truss member in a bottom position and a third truss member in a top position.

5. A truss boom according to claim 4, wherein the three truss frame members are oriented in a triangular configuration with the first and second truss members defining a triangle base and the third truss member defining a triangle apex.

6. A truss boom according to claim 5, wherein the three truss frame members are further oriented in a pyramidal configuration with the one end of the truss members affixed to the connector frame defining a pyramid base and the opposite end of the truss members affixed to the end bracket defining a pyramid apex.

7. A truss boom according to claim 1, further comprising slider pads mounted in the extension opening, wherein the extension member is displaceable in the extension opening on the slider pads.

8. A truss boom according to claim 1, wherein the extension member is lockable in a selected position by a removable pin.

9. A materials handling vehicle comprising:
a vehicle chassis;
a telescoping boom pivotably supported at one end on the vehicle chassis;
a load support mechanism pivotably supported on an opposite end of the telescoping boom; and
a truss boom coupled with the load support mechanism, the truss boom comprising:
a connector frame coupled with the load support mechanism,
a plurality of truss frame members affixed at one end to the connector frame and at an opposite end to an end bracket, the end bracket defining an extension opening, and
an extension member movably supported by the end bracket in the extension opening, the extension member being selectively lockable in the extension opening in a plurality of positions between a fully retracted position and a fully extended position.

10. A truss boom attachable to a materials handling vehicle, the truss boom comprising:
a connector frame coupleable with the materials handling vehicle;
an end bracket having exterior surfaces defining connection surfaces and interior surfaces defining an extension opening;
a plurality of truss frame members affixed at one end to the connector frame and at an opposite end to respective connection surfaces of the end bracket; and
an extension member movably supported by the end bracket in the extension opening, the extension member being selectively lockable in the extension opening in a plurality of positions between a fully retracted position and a fully extended position.

11. A truss boom according to claim 10, comprising three truss frame members.

12. A truss boom according to claim 11, wherein the three truss frame members are configured with a first truss member and a second truss member in a bottom position and a third truss member in a top position.

13. A truss boom according to claim 12, wherein the three truss frame members are oriented in a triangular configuration with the first and second truss members defining a triangle base and the third truss member defining a triangle apex.

14. A truss boom according to claim 13, wherein the three truss frame members are further oriented in a pyramidal configuration with the one end of the truss members affixed to the connector frame defining a pyramid base and the opposite end of the truss members affixed to the end bracket defining a pyramid apex.

15. A truss boom according to claim 10, further comprising slider pads mounted in the extension opening, wherein the extension member is displaceable in the extension opening on the slider pads.

16. A truss boom according to claim 10, wherein the extension member is lockable in a selected position by a removable pin.
